(19) United States
(12) Patent Application Publication
(10) Pub. No.: US 2006/0007139 A1
(43) Pub. Date: Jan. 12, 2006

(54) Device and method for configuring a user operated screen controller

(76) Inventor: Dee Nai Ong, Singapore (SG)

Correspondence Address: MOTOROLA INC, 600 NORTH US HIGHWAY 45, ROOM AS437, LIBERTYVILLE, IL, 60048-5343, US

(21) Appl. No.: 10/859,756

(22) Filed: Jun. 3, 2004

(51) Int. Cl. G09G 5/08

(52) U.S. Cl. 345/157

(57) ABSTRACT

A closeable radio communications device (100) comprising a housing (210) having at leat two portions (220,230) pivotally mounted to each other about a pivotal axis (A) to allow relative movement of the portions between a closed position and an opened position. The device has a processor (103) housed within the housing (210) and a display screen (105) is mounted to the housing (210). A position detector module (125) is operatively coupled to the processor (103) and a user operated screen controller (130) is mounted to the housing (210) and operatively coupled to the processor (103). In use, the position detector module (125) provides position signals to the processor (103), the position signals being indicative of the relative positions of the two portions (220,230), and in response to the position signal the processor (103) configures operation of the user operated screen controller (130) to control movement of an object (OB) displayed on the display screen (105).

### FIELD OF THE INVENTION

This invention relates to the field of electronic devices with a two-part housing. The invention is particularly useful, but not necessarily limited to, portable or hand held closeable electronic devices that have a two-part housing movable about a pivotal axis between a closed an opened position to facilitate usage.

### BACKGROUND OF THE INVENTION

Portable electronic devices, such as radio, cellular (mobile) telephone or other radio communications devices that are easy to transport are becoming commonplace. Such portable electronic devices come in a variety of different form factors and support many features and functions.

For purposes of convenience there is a general trend toward miniaturization of many types of portable electronic devices. Miniaturization generally makes it easier to carry the electronic device, including fitting the device into a user's pocket/purse or attaching the device to a user's belt.

While generally there is a requirement to reduce a device's form factor as much as possible, in several specific instances the extent to which the size of a device can be reduced is limited by other countervailing requirements. In some instances, the extent to which the size of a device can be reduced is limited by minimum size requirements that may be necessary for a person to conveniently use and/or interact with the device. For example, a keypad can only be reduced in size so far before it becomes difficult to operate. A keypad generally needs to accommodate the size of the user's hands and/or fingers. Similarly, devices that accommodate two-way communication generally need to accommodate a microphone proximate a user's mouth and a speaker proximate a user's ear.

In order to meet the above requirements, while otherwise attempting to minimize the device's overall size, many manufacturers have introduced devices having two part housings that fold with respect to one another, thereby allowing the device to fold open when being used and to fold closed when not being used. This allows a device, such as a cellular telephone, to be more conveniently stored when not being used, and allows the device to expand to a convenient size commensurate with usage needs.

Previous wireless communication devices have incorporated two part housings, which fold to an opened position when being used and fold to a closed position when not being used. In the opened position, a conventional user interface includes a communications speaker, a microphone, a display and a keypad all of which are operable and accessible to a user. Also, in the opened position, the device has a length that is sufficient to allow the ear and mouth of the user to align respectively with the speaker and microphone. In contrast, in the closed position some parts or all of the user interface may not be accessible to a user and the device is shorter in length. It is therefore relatively easy for a user to store the device in a convenient place such a pocket, bag, purse or holster.

One commonly used two part housing device has a flip-type or clam shell design, which generally includes a display screen mounted to one of two housing portions that is pivotally coupled together by a hinge. The two housing portions pivot with respect to one another along a pivotal axis that is substantially parallel to a plane of a viewing surface of the display screen.

Another previous two part housing device has two housing portions that rotate with respect to one another around an axis of rotation perpendicular to the plane of the viewing surface of the display screen. In at least one well-known device, the housing portions can rotate to an opened position in either a clockwise direction or a counter-clockwise direction. Such a device is disclosed in U.S. application identified by Ser. No. 09/826,180, entitled “Rotational Mechanism for a Wireless Communication Device”, filed Apr. 4, 2001, the disclosure of which is incorporated herein by reference.

When using the above two part housing devices, particularly devices with an axis of rotation perpendicular to the plane of the visual display's viewing surface, the orientation or configuration of user screen controllers (i.e. cursor control keys) may become intuitively compromised (counter intuitive) depending upon the relative positions of the housing portions. Furthermore, the orientation of a visual representation displayed on the display screen may compound the counter intuitive orientation or configuration of the screen controller. For instance, when in a fully closed position an “up” function key is usually above a “down” function key. However when the housing portion to which these keys are mounted is rotated 180 degrees to a fully opened position, the “down” function key will be located above the “up” function key. Similarly, the locations of a “left” function key and “right” function key will be reversed when the housing portion to which they are mounted is rotated 180 degrees from a closed to an opened position. It would therefore be ergonomically beneficial to automatically change the function of a key based on at least the relative positions of the housing portions.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a closeable electronics device comprising: a housing having at least two portions movably mounted to each other about a pivotal axis to allow relative positions of the portions to be selected between a closed position and an opened position; a processor housed within the housing; a display screen mounted to the housing; a position detector module operatively coupled to the processor; and a user operated screen controller mounted to the housing and operatively coupled to the processor, wherein in use the position detector module provides at least one position signal to the processor, the position signal being indicative of at least the relative positions of the two portions, and in response to the position signal the processor configures operation of the user operated screen controller to control movement of at least one object displayed on the display screen.

According to another aspect of the invention there is provided a closeable electronics device comprising: a housing having at least two portions movably mounted to each other about a pivotal axis to allow relative positions of the portions to be selected between a closed position and an opened position; a processor housed within the housing; a display screen mounted to the housing; a position detector module operatively coupled to the processor; and a user operated screen controller mounted to the housing and operatively coupled to the processor, wherein in use actuation of the user operated screen controller provides screen control signals that are processed by the processor to control movement of at least one object displayed on the display screen, the screen control signals being dependent on at least one position signal from the position detector module and the position signal being indicative of at least the relative positions of the two portions.

Suitably, the object is associated with an image displayed on the display screen.

Preferably, in use, orientation of the image displayed on the display screen is dependent on the position signal.

Suitably, the position detector module comprises a plurality of position detectors including relative position detectors providing at least one relative orientation signal detecting the relative positions of the two portions, wherein the position signal comprises the relative orientation signal.

Preferably, the relative position detectors provide the relative orientation signal that is indicative of a fully opened position and a fully closed position of the portions. Suitably, the relative position detectors provide the relative orientation signal that is indicative of intermediate positions disposed between the fully opened position and a fully closed position of the portions.

Preferably, the plurality of position detectors includes absolute position detectors for providing at least one absolute orientation signal for detecting absolute positions of the portions relative to the earth's surface, wherein the position signal comprises the absolute orientation signal.

Preferably, the display has a viewing surface that is transverse to the pivotal axis. The pivotal axis is preferably perpendicular to the viewing surface of the display screen.

Suitably, the user operated screen controller is a group of switches. The group of switches preferably include two opposing pairs of switches to provide up, down, left and right movement of the object displayed on the display screen.

Preferably, the object displayed on the display screen is a cursor or a pointer or an icon or any visual representation.

Suitably, the user operated screen controller may be a joystick.

Suitably, the user operated screen controller may be an input tablet.

According to another aspect of the invention there is provided a method for configuring operation of a user operated screen controller of a closeable electronics device having a display screen and two portions moveably mounted to each other about a pivotal axis, the method comprising: determining relative positions of the two portions to provide a position signal; and configuring operation of the user operated screen controller based on the position signal to thereby control movement of at least one object displayed on the display screen.

Suitably, orientation of a visual representation displayed on the display screen is dependent on the position signal.

Suitably, the object is associated with an image displayed on the display screen. Preferably, the object displayed on the display screen is a cursor or a pointer or an icon or any visual representation.

Preferably, orientation of the image displayed on the display screen is dependent on the position signal.

Suitably, the position signal comprises: a relative orientation signal that detects the relative positions of the two portions; and an absolute orientation signal for detecting absolute positions of the portions relative to the earth's surface.

Preferably, the method is further characterised by the user operated screen controller being a group of switches. The group of switches preferably include two opposing pairs of switches to provide up, down, left and right movement of the object displayed on the display screen.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a block diagram illustrating circuitry of a closeable electronics device in accordance with the invention;

FIG. 2 illustrates the closeable electronics device of FIG. 1 when in a fully closed position;

FIG. 3 illustrates the closeable electronics device of FIG. 1 when in a fully opened position and intermediate positions;

FIGS. 4,5,6 and 7 illustrate schematic operation of position detectors for the closeable electronics device of FIG. 1;

FIGS. 8,9,10 and 11 illustrate further positions and orientations for the closeable electronics device of FIG. 1; and

FIG. 12 illustrates a method for configuring operation of a user operated screen controller of closeable electronics device of FIG. 1.

### DETAILED DESCRIPTION OF THE PREFERRED EMBODIMENT OF THE INVENTION

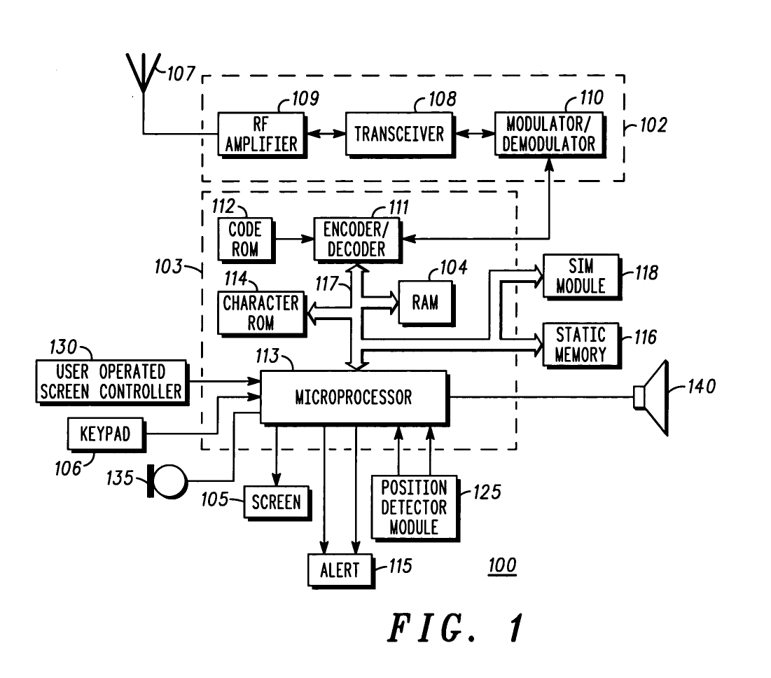

In the drawings, like numerals on different Figs are used to indicate like elements throughout. With reference to FIG. 1, there is illustrated a closeable electronics device in the form a radio telephone 100 comprising a radio frequency communications unit 102 coupled to be in communication with a processor 103. The radio telephone 100 also has a keypad 106 and a display screen 105 coupled to be in communication with the processor 3. As will be apparent to a person skilled in the art, screen 105 may be a touch screen thereby making the keypad 106 optional. There is also a user operated screen controller 130 and a housing position detector module 125, operatively coupled to the processor 103 to provide housing position signals (PS), the position detector module 125 typically comprising a combination of mechanically actuated push button switches and accelerometers, however, the position detector module 125 can comprise any suitable detectors such as a magnetic sensors (reed switches), capacitance sensors, inductance sensors, potentiometers, hall effect sensors, gravity actuated biased switches or photo sensors.

The processor 103 includes an encoder/decoder 111 with an associated Code Read Only Memory (ROM) 112 storing data for encoding and decoding voice or other signals that may be transmitted or received by the radio telephone 100. The processor 103 also includes a micro-processor 113 coupled, by a common data and address bus 117, to the encoder/decoder 111, a character Read Only Memory (ROM) 114, a Random Access Memory (RAM) 104, static programmable memory 116 and a removable SIM module 118. The static programmable memory 116 and SIM module 118 each can store, amongst other things, selected incoming text messages and a Telephone Number Database TND (phonebook) comprising a number field for telephone numbers and name field for identifiers associated with one the numbers in the name field. For instance, one entry in the Telephone Number Database TND may be 91999111111 (entered in the number field) with an associated identifier “Steven C at work” in the name field.

The micro-processor 113 has ports for coupling to the keypad 106 screen 105 and an alert module 115 that typically contains an alert speaker, vibrator motor and associated drivers. Also, micro-processor 113 has ports for coupling to a microphone 135 and communications speaker 140. The character Read only memory 114 stores code for decoding or encoding text messages that may be received by the communication unit 102. In this embodiment the character Read Only Memory 114 also stores operating code (OC) for micro-processor 113 and code for performing functions associated with the radio telephone 1.

The radio frequency communications unit 102 is a combined receiver and transmitter having a common antenna 107. The communications unit 102 has a transceiver 108 coupled to antenna 107 via a radio frequency amplifier 109. The transceiver 108 is also coupled to a combined modulator/demodulator 110 that couples the communications unit 102 to the processor 103.

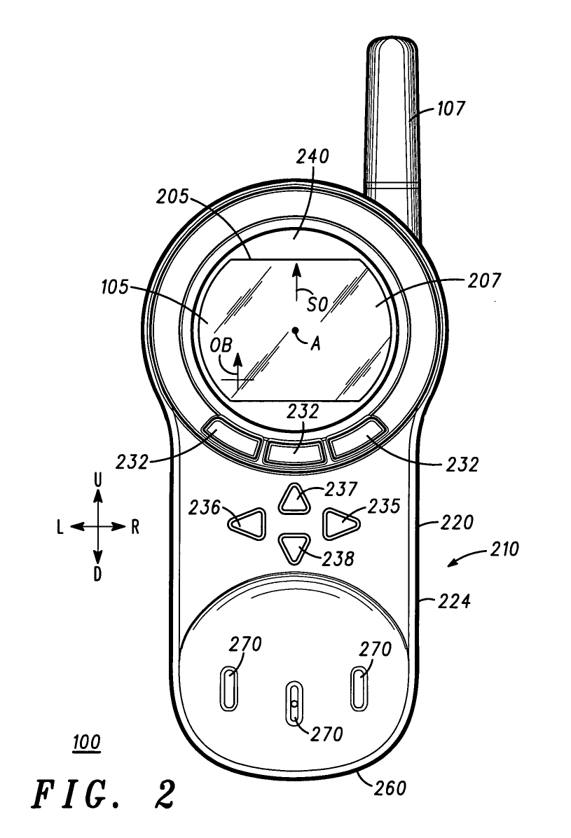

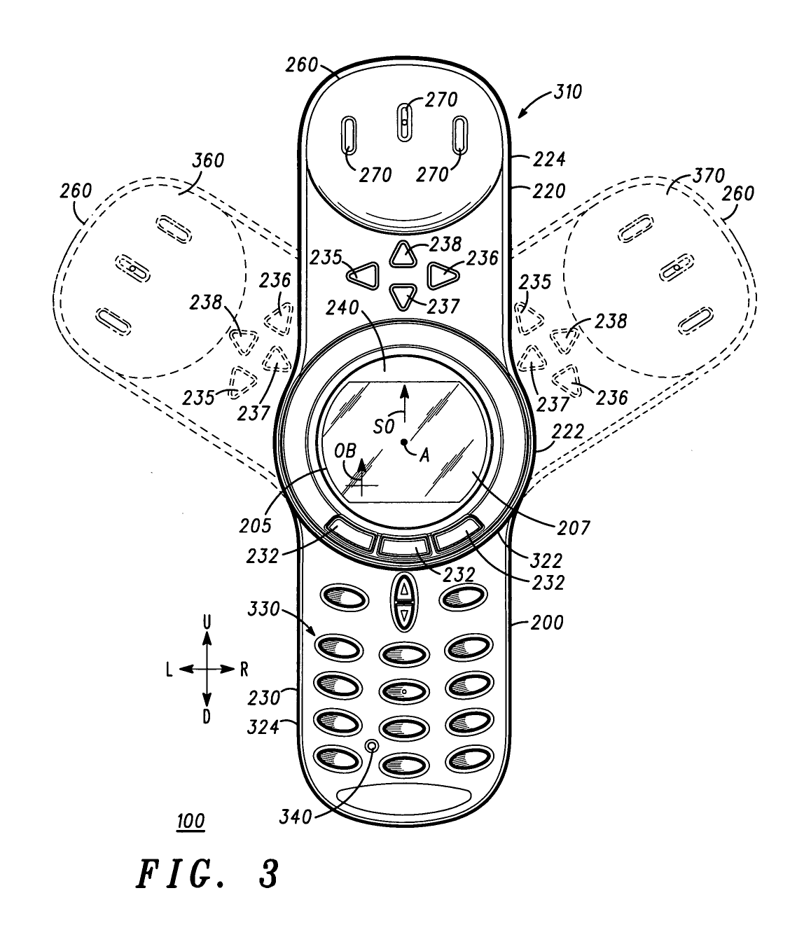

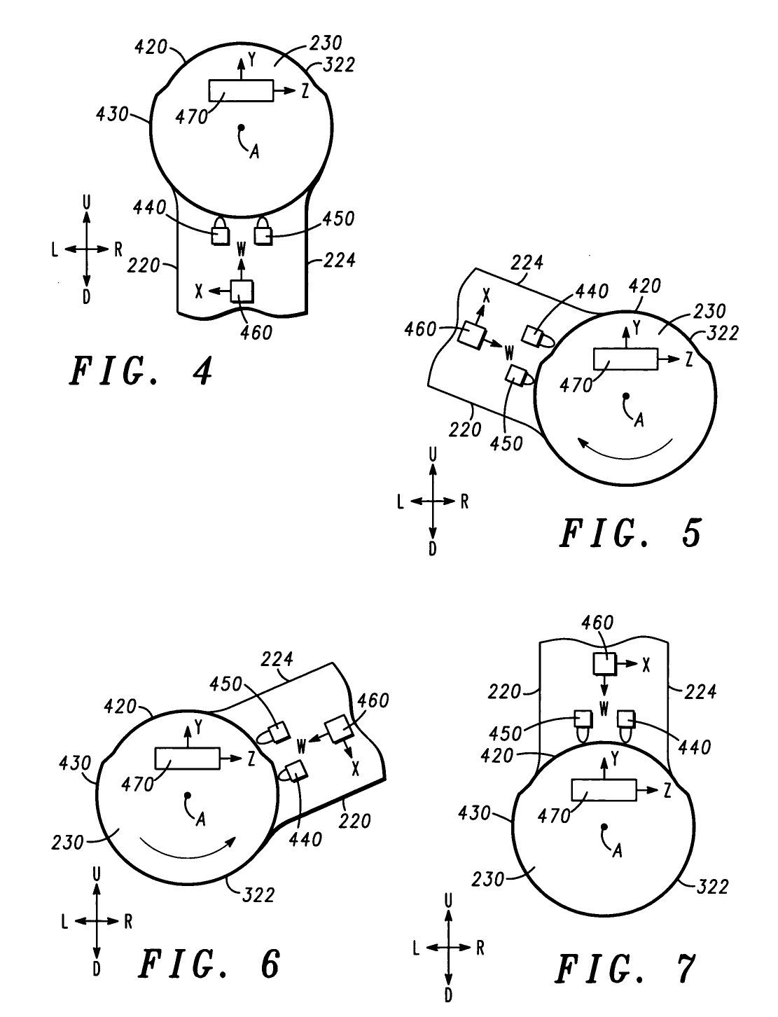

Referring to FIGS. 2 and 3 there is illustrated a first embodiment of the closeable (foldable) electronics device in the form of the radio telephone 100 often referred to as a mobile or cellular telephone. The radio telephone 100 has a housing 200 with two portions 220, 230 movably mounted to each other to allow relative movement of the portions 220,230 between a fully closed position of FIG. 2 and a fully opened position of FIG. 3. Housed, or partially disposed, in the housing 200 are the components of FIG. 1 including the transceiver 108 and processor 103.

The relative movement, as shown in this embodiment, is achieved by the portions 220,230 being pivotally mounted to each other about a pivotal axis A that is perpendicular to a viewing surface 207 of the display screen 105. As will be apparent to a person skilled in the art, the viewing surface 207 is the surface of the display 105 facing a user when viewing the display 105. In the fully closed position, indicated by reference numerals 210, there are a group of switches or keys 235,236,237,238 comprising the user operated screen controller 130, that is mounted to the housing 200, and the display screen 105 are visible and accessible by a user. The switches or keys 235-238 and user operated screen controller 130 are disposed in portion 220. In contrast, the keypad 106 includes a plurality of associated keys 330, disposed in portion 230 and are totally hidden (sandwiched between portions 220,230) and inaccessible by a user when the housing 200 is in the fully closed position 210.

The portion 220 is generally elongated and of a substantially planar shape. The portion 220 has a circular sub-portion 222 at one end and an extending sub-portion 224 extending away from the circular sub-portion 222. In the fully closed position 210, the circular sub-portion 222 and the extending sub-portion 224 are adjacent to, and overlay, portion 230. Further, as will be apparent to a person skilled in the art, in this embodiment the display screen 105 is mounted to the housing 200, more specifically the display screen 105 is fixed to portion 230.

Some components of the radio telephone 100 are positioned proximal to the circular sub-portion 222 including an interchangeable cover 231 and the display screen 105. The interchangeable cover 231 has a ring-like (annular) shape that may be attached to, and detached from, the radio telephone 100. In addition, the interchangeable cover 231 may include selection buttons 232 that can be preferably associated with the user operated screen controller 130, to provide additional functionality to the radio telephone 100. For example, in this preferred embodiment there are three selection buttons 232.

The display screen 105 may be any type of output device that provides a convenient display of text, menus and/or graphics to the user. Preferably, the display screen 105 is a liquid crystal display having a backlighting system to illuminate the display screen 105 when ambient lighting conditions are insufficient for adequate viewing by the user. A locking piece 240 is disposed inside the circular sub-portion 222 and functions as a lens to protect and hold in place the display screen 105. The locking piece 240 also locks certain components of the radio telephone 100 together, which is explained in detail by referring to U.S. application identified by Ser. No. 09/826,180 incorporated herein by reference. The locking piece 240 also functions as a display lens to protect the display screen 150.

A free end 260 of the extending portion 224 includes speaker apertures 270 that, amongst other functions, direct sounds, generated by the communications speaker 140, out of the housing 200. In this embodiment, when in the fully closed position 210, the keys 235,236,237,238 typically perform the following allocated functions: Key 235 is cursor move right; Key 236 is cursor move left; Key 237 is cursor move up; and Key 238 is cursor move down. However, as will be apparent to a person skilled in the art, the keys 235-238 form part of the user operated screen controller 130 and provides screen control signals, by user operation, that control movement of one or more objects (OB) displayed on the display screen 105. Although in this embodiment the user operated screen controller 130 comprises the keys 235-238, the screen controller 130 may comprise other user input technology such as a joystick or a touch sensitive tablet.

Hence, in addition to cursor movement, the keys 235-238 can control screen pointer movement or movement of any screen or object (OB) displayed on the screen 105. For example, Keys 235-238 may move an object (OB) up, down, left or right as part of a game being played and displayed on screen 105. From the above, it will be apparent that the group of switches or keys 235-238 include two opposing pairs of switches or keys to provide up, down, left and right movement of an object (OB) such as a cursor, pointer, icon or any visual representation displayed on the display screen 105. One of these opposing pairs comprises keys 235,236 and the other opposing pair comprises keys 237,238.

Referring specifically to FIG. 3, the preferred embodiment of the radio telephone 100 is shown in the fully opened position indicated by reference numerals 310. When in the fully opened position 310, both the keys 330 and a microphone aperture 340 become visible, the microphone aperture 340 in use provides for directing sounds received from the user or other local sounds to the microphone 135. Similar to the portion 220, the portion 230 includes a circular sub-portion 322 and an extending substantially planar sub-portion 324. In this fully opened position 310, the circular sub-portion 222 of the sub-portion 220 is adjacent to, and positioned above, the circular sub-portion 322. On the other hand, the extending sub-portion 224 is positioned opposite the extending sub-portion 324 on opposite sides of the circular sub-portions 222 and 322. The keys 330 may include any layout of keys that provide convenient operation of the radio telephone 100 by the user.

The relative positions of the portions 220,230 are not restricted the fully opened position 310 and the fully closed position 210 described above. The preferred embodiment shown in FIGS. 2 and 3 includes four functional positions, namely the fully opened position 310, fully closed position 210, and auxiliary or intermediate positions 360 and 370. The intermediate positions 360 and 370 are positions that are partially opened positions between the fully closed 210 and fully opened positions 310. Generally, the fully opened position 310 and the fully closed position 210 may respectively activate and de-activate functions of the radio telephone 100 such as answering an incoming call and terminating an existing call. Each of the intermediate positions 360 and 370 may also be set to activate a particular function of the radio telephone 100. For example, intermediate position 360 may operate to illuminate the display screen 105 (without answering an incoming call, if one exists), and intermediate position 370 may operate to provide caller identification information about an incoming call that is not provided in the fully closed position 210.

Another function that may be activated by the functional positions of the portions 220,230 includes changing between different modes of operation for a multimode device. For example, the relative position of the extending sub-portions 224, 324 may determine whether the radio telephone 100 operates as a pager, a network browser, an e-mail device, a personal digital assistant, a games playing device or an audio player.

As will be apparent to a person skilled in the art, when the relative positions 210, 310, 360, 370 of the portions 220, 230 are selected by pivotal movement thereof about the pivotal axis A, the choice of functions for each of the keys 235-238 may become counter intuitive. Also, depending on the absolute orientations of portions 220,230, the orientations of images displayed on the screen 105 and keys 235-238 can be inconvenient and counter intuitive to use in prior art devices. In the rest of this specification, screen orientation reference directions up, down, left, right when portions 220, 230 are in the fully closed position 210 are indicated by respective arrows U,D,L,R. As shown in FIGS. 2 and 3, the display screen 105 orientation remains unchanged since the portion 230 to which it is fixed remains in the same (upright) orientation.

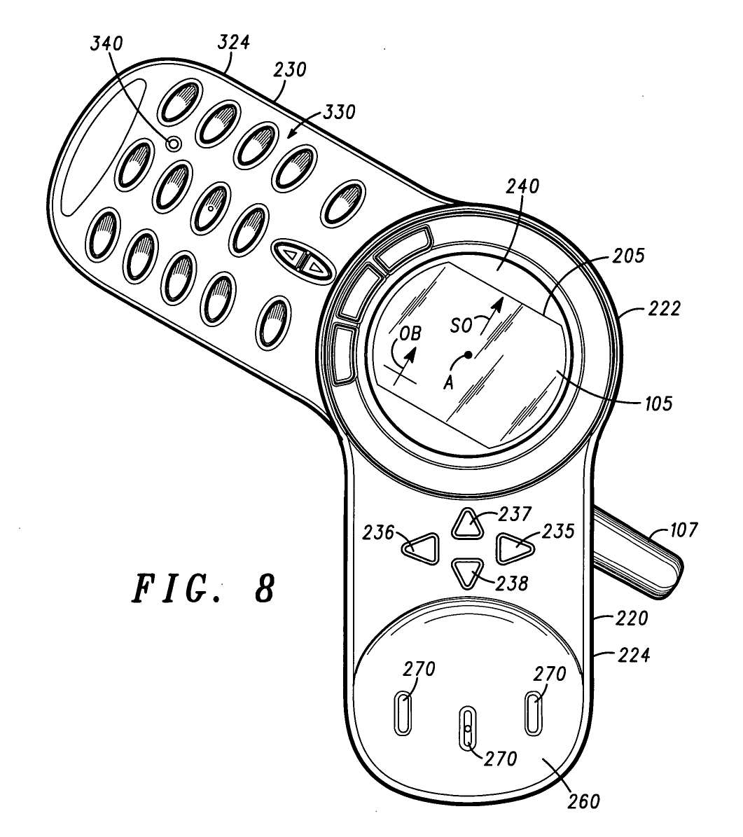

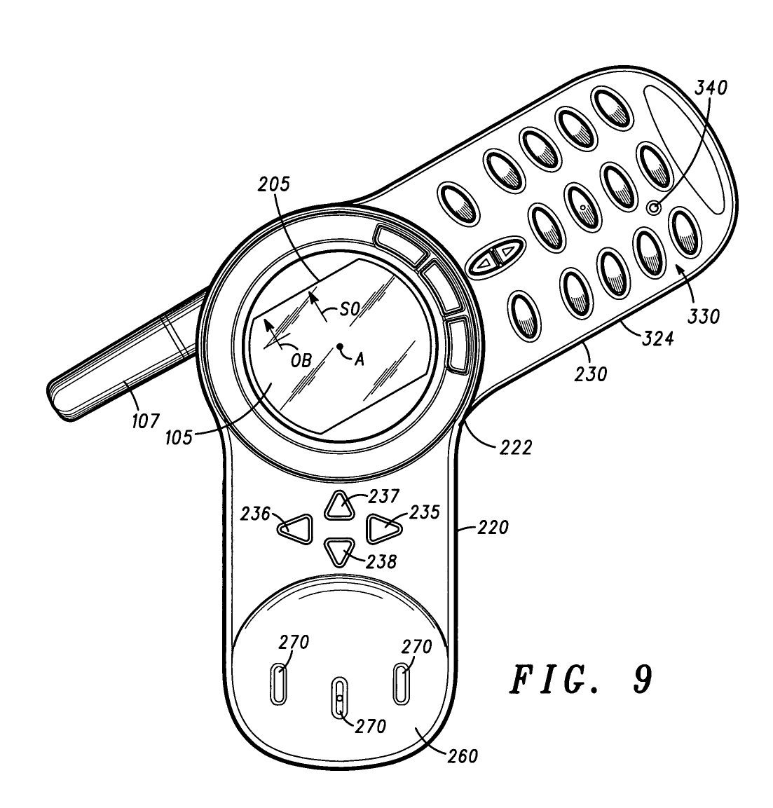

Referring to FIGS. 4 to 7, there are illustrated schematic representations the position detector module 125 operation. The position detector module 125 comprises relative position detectors that provide at least one relative orientation signal detecting the relative positions of the two portions 220,230. In this embodiment, the relative position detectors are normally closed switches 440, 450 mounted to the extending sub-portion 224 adjacent and in a co-active arrangement with a cam 420 comprising a raised switch actuating track 430. The position detector module 125 also comprises absolute position detectors 460, 470 for detecting absolute positions of the portions 220,230 relative the earth's surface. These absolute position detectors 460, 470 provide an absolute orientation signal and are typically accelerometers and use the earth's gravitational force as an absolute reference. As illustrated, the absolute position detector 460 is mounted to portion 220 and detects the absolute position in two directions illustrated by arrows W and X. Hence, if portion 220 is oriented such that either directions W or X are at an angle below a horizontal plane (i.e. pointing in a downwards direction) then absolute position detector 460 provides a signal (in this embodiment a logic 1) indicating that portion 220 is in a position other than upright. However, it should be noted that not all positions other than upright will result in the absolute position detector 460 providing the logic 1 signal.

Also, as illustrated, the absolute position detector 470 is mounted to portion 230 and senses the absolute position in two directions illustrated by arrows Y and Z. Hence, if portion 230 is oriented such that either directions Y or Z are at an angle below a horizontal plane (pointing in a downwards direction) then absolute position detector 470 provides an absolute position signal (in this embodiment a logic one) indicating that portion 230 is in a position other than upright. Again, it should be noted that not all positions other than upright will result in the absolute position detector 470 providing the logic one absolute position signal.

As illustrated, specifically in FIG. 4, the housing 200 is in the fully closed position 210. Assuming that W is pointing vertically upwards, then absolute position detectors 460,470 provide logic zero absolute position signals to processor 103. Also, both normally closed switches 440,450 are actuated by switch actuating track 430 thereby providing logic zeros relative position signals to processor 103.

In FIG. 5, the relative positions of the portions 220,230 provide for the intermediate position 360 of the housing 200. Position detector 460 provides a logic one absolute position signal to processor 103 and position detector 470 provides a logic zero absolute position to processor 103. The normally closed switch 440 is no longer in contact with switch actuating track 430 thereby providing logic one relative position to processor 103, whereas normally closed switch 450 is in contact with switch actuating track 430 thereby providing a logic zero relative position to processor 103.

In FIG. 6, the relative positions of the portions 220,230 provide for the intermediate position 370 of the housing 200. Position detector 460 provides a logic one absolute position to processor 103 and position detector 470 provides a logic zero absolute position to processor 103. The normally closed switch 450 is no longer in contact with switch actuating track 430 thereby providing logic one relative position to processor 103, whereas normally closed switch 440 is in contact with switch actuating track 430 thereby a providing logic zero relative position to processor 103.

In FIG. 7, the relative positions of the portions 220,230 provide for the fully opened position 310 of the housing 200. Position detector 460 provides a logic one absolute position to processor 103 and position detector 470 provides a logic zero absolute position to processor 103. The normally closed switches 440,450 are not in contact with switch actuating track 430 thereby both providing a logic one relative position to processor 103.

When considering the above description for absolute position signals, it will be apparent that other absolute position signals can be generated. A complete truth table list of useful relative and absolute positions of portions 220, 230 is provided in table 1 of this specification.

Referring to table 1, assuming keys 235-238 control a pointer PT displayed on the display screen 105, then condition 1 corresponds to the fully closed position 210 in which the Screen Orientation indicated by arrow SO of a display or image 205 displayed on the display screen 105 is aligned to the up direction U. Also, key 235 is designated for controlling the pointer PT on display screen 105 to thereby move the Pointer PT in the right direction R, key 236 is designated for moving is designated for moving Pointer PT in the left direction L, key 237 for moving the Pointer PT in the up direction U and key 238 is designated for moving Pointer PT in the down direction D.

Condition 15 corresponds to the fully opened position 260 in which the Screen Orientation SO of the display or image 205 displayed on the display screen 105 is aligned to the up direction U. Also, key 235 is designated for controlling the pointer to move in the left direction L, key 236 is designated for moving is designated for moving Pointer PT in the right direction R, key 237 for moving the Pointer PT in the down direction D and key 238 is designated for moving Pointer PT in the up direction U.

Condition 11 corresponds to the intermediate position 360 in which the Screen Orientation SO of the display or image 205 displayed on the display screen 105 is aligned to the up direction U. Also, key 235 is designated for controlling the pointer to move in the down direction D, key 236 is designated for moving is designated for moving Pointer PT in the up direction U, key 237 for moving the Pointer PT in the right direction R and key 238 is designated for moving Pointer PT in the left direction L.

Condition 7 corresponds to the intermediate position 370 in which the Screen Orientation SO of the display or image 205 displayed on the display screen 105 is aligned to the up direction U. Also, key 235 is designated for controlling the pointer to move in the up direction U, key 236 is designated for moving is designated for moving Pointer PT in the down direction D, key 237 for moving the Pointer PT in the left direction L and key 238 is designated for moving Pointer PT in the right direction R.

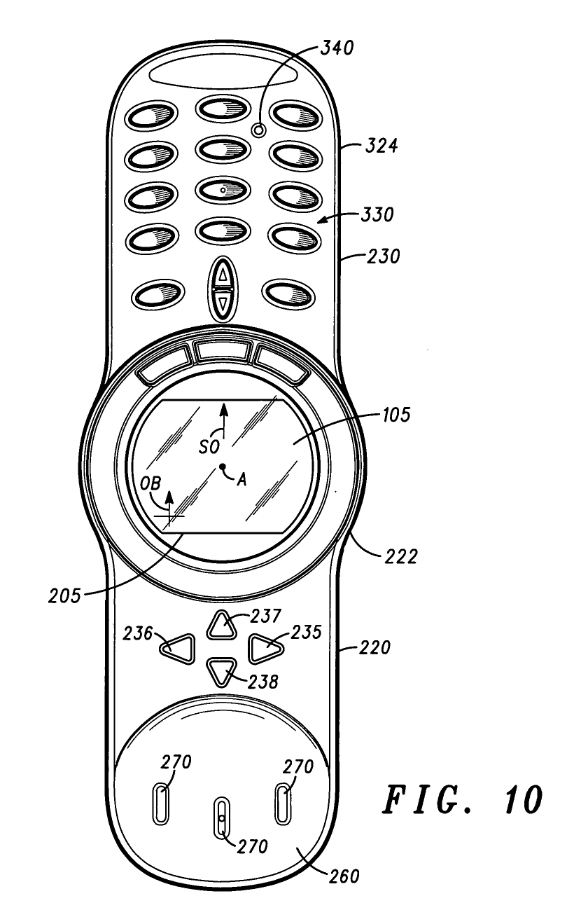

The above four conditions 1,7,11,15 are for the four functional positions as illustrated in FIGS. 2 and 3. However many other orientations of these relative four positions are possible resulting in the other conditions in table 1. It should be noted that in this embodiment condition 5 cannot occur (impossible condition). Four examples of other functional positions resulting four further ones of the conditions of table 1 are illustrated with reference to FIGS. 8 to 11.

In FIG. 8, condition 6 is illustrated in which position detector 460 provides a logic zero absolute position to processor 103 and position detector 470 provides a logic one absolute position to processor 103. In this orientation, the intermediate position is position 370 but the Screen Orientation SO of the display or image 205 displayed on the display screen 105 is aligned to the L reference direction. Also, key 235 is designated for controlling the pointer PT to move in the right direction R, key 236 is designated for moving is designated for moving Pointer PT in the left direction L, key 237 for moving the Pointer PT in the up direction U and key 238 is designated for moving Pointer PT in the down direction D.

In FIG. 9, condition 10 is illustrated in which position detector 460 provides a logic zero absolute position to processor 103 and position detector 470 provides a logic one absolute position to processor 103. In this orientation, the intermediate position is position 360 but the Screen Orientation SO of the display or image 205 displayed on the display screen 105 is aligned to the R reference direction. Also, key 235 is designated for controlling the pointer PT to move in the right direction R, key 236 is designated for moving is designated for moving Pointer PT in the left direction L, key 237 for moving the Pointer PT in the up direction U and key 238 is designated for moving Pointer PT in the down direction D.

In FIG. 10, condition 14 is illustrated in which position detector 460 provides a logic zero absolute position to processor 103 and position detector 470 provides a logic one absolute position to processor 103. In this orientation, the fully opened position 310 is illustrated but the Screen Orientation SO of the display or image 205 displayed on the display screen 105 is aligned to the D reference direction. Also, key 235 is designated for controlling the pointer PT to move in the right direction R, key 236 is designated for moving is designated for moving Pointer PT in the left direction L, key 237 for moving the Pointer PT in the up direction U and key 238 is designated for moving Pointer PT in the down direction D.

In FIG. 11, condition 16 is illustrated in which position detector 460 provides a logic one absolute position to processor 103 and position detector 470 also provides a logic one absolute position to processor 103. In this orientation, the fully opened position 310 is illustrated but the Screen Orientation SO of the display or image 205 displayed on the display screen 105 is aligned to the L reference direction. Also, key 235 is designated for controlling the pointer PT to move in the up direction U, key 236 is designated for moving is designated for moving Pointer PT in the down direction D, key 237 for moving the Pointer PT in the left direction L and key 238 is designated for moving Pointer PT in the right direction R.

TABLE 1

| Condition | 440 | 450 | 460 | 470 | 235 | 236 | 237 | 238 | SO |
|---|---|---|---|---|---|---|---|---|---|
| 1 | 0 | 0 | 0 | 0 | Right | Left | Up | Down | U |
| 2 | 0 | 0 | 0 | 1 | Down | Up | Right | Left | L |
| 3 | 0 | 0 | 1 | 0 | Up | Down | Left | Right | R |
| 4 | 0 | 0 | 1 | 1 | Left | Right | Down | Up | D |
| 5 | 0 | 1 | 0 | 0 | # | # | # | # | # |
| 6 | 0 | 1 | 0 | 1 | Right | Left | Up | Down | L |
| 7 | 0 | 1 | 1 | 0 | Up | Down | Left | Right | U |
| 8 | 0 | 1 | 1 | 1 | Up | Down | Left | Right | L |
| 9 | 1 | 0 | 0 | 0 | Down | Up | Right | Left | R |
| 10 | 1 | 0 | 0 | 1 | Right | Left | Up | Down | R |
| 11 | 1 | 0 | 1 | 0 | Down | Up | Right | Left | U |
| 12 | 1 | 0 | 1 | 1 | Up | Down | Left | Right | L |
| 13 | 1 | 1 | 0 | 0 | Down | Up | Right | Left | R |
| 14 | 1 | 1 | 0 | 1 | Right | Left | Up | Down | D |
| 15 | 1 | 1 | 1 | 0 | Left | Right | Down | Up | U |
| 16 | 1 | 1 | 1 | 1 | Up | Down | Left | Right | L |

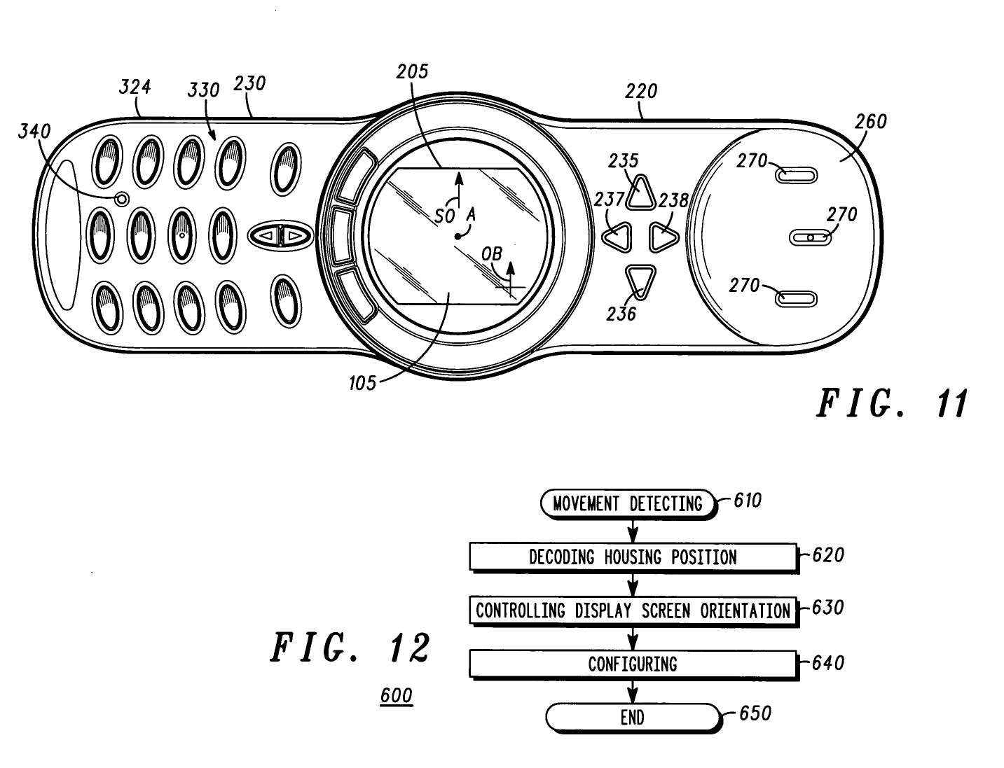

Referring now to FIG. 12, there is illustrated a method 600 for configuring operation of the user operated screen controller 130 of the closeable electronics device 100. The method 600 is invoked by the position detector module 125 detecting movement at step 610, this movement being either relative movement of the portions 220, 230 or absolute movement that is detected by a change from one of the conditions of table 1 to another one of the conditions. A determining step 620 then provides for determining relative positions of the two portions 220, 230 to provide a position signal. A controlling display screen orientation step 630 then controls the orientation of the image 205 displayed on display screen 105. The orientation of the image 205 is dependent on the position signal that comprises the relative orientation signal (detecting the relative positions of the two portions 220,230) and the absolute orientation signal (the portions 220,230 relative the earth's surface).

The method 600 then effects a step of configuring 640 for configuring operation of the user operated screen controller 130 based on the position signal provided to the processor 103 to thereby control movement of the at least one object (OB) displayed on the display screen 105. In other words, in use, actuation of the user operated screen controller 130 provides screen control signals that are processed by the processor 103 to control movement of the object (OB) displayed on the display screen 105. These screen control signals are dependent on the position signal from the position detector module 125 that is indicative of the relative positions of the two portions 220,230. The method then terminates at an end step 650 and will be invoked again by the position detector module 125 detecting movement.

Advantageously, the present invention provides for configuring or processing signals from the user operated screen controller 130 that taking into account the relative and absolute positions (orientations) of the housing 200. This allows for an intuitive user operated screen controller 130 that is orientated to correspond to the orientation of the image 205 displayed on the display screen 105.

The detailed description provides preferred exemplary embodiments only, and is not intended to limit the scope, applicability, or configuration of the invention. Rather, the detailed description of the preferred exemplary embodiments provides those skilled in the art with an enabling description for implementing preferred exemplary embodiments of the invention. It should be understood that various changes may be made in the function and arrangement of elements without departing from the spirit and scope of the invention as set forth in the appended claims. For instance, the display screen 105 may be any shape or size and can be disposed anywhere on either of the portions (220,230).

We claim:

1. A closeable electronics device comprising:
a housing having at least two portions movably mounted to each other about a pivotal axis to allow relative positions of the portions to be selected between a closed position and an opened position;
a processor housed within the housing;
a display screen mounted to the housing;
a position detector module operatively coupled to the processor; and
a user operated screen controller mounted to the housing and operatively coupled to the processor, wherein in use the position detector module provides at least one position signal to the processor, the position signal being indicative of at least the relative positions of the two portions, and in response to the position signal the processor configures operation of the user operated screen controller to control movement of at least one object displayed on the display screen.

2. A closeable electronics device, as claimed in claim 1, wherein the object is associated with an image displayed on the display screen.

3. A closeable electronics device, as claimed in claim 2, wherein in use, orientation of the image displayed on the display screen is dependent on the position signal.

4. A closeable electronics device, as claimed in claim 1, wherein the position detector module comprises a plurality of position detectors including relative position detectors providing at least one relative orientation signal detecting the relative positions of the two portions, and wherein the position signal comprises the relative orientation signal.

5. A closeable electronics device, as claimed in claim 4, wherein the relative position detectors provide the relative orientation signal that is indicative of a fully opened position and a fully closed position of the portions.

6. A closeable electronics device, as claimed in claim 4, wherein the relative position detectors provide the relative orientation signal that is indicative of intermediate positions disposed between the fully opened position and a fully closed position of the portions.

7. A closeable electronics device, as claimed in claim 4, wherein the plurality of position detectors includes absolute position detectors for providing at least one absolute orientation signal for detecting absolute positions of the portions relative to the earth's surface, wherein the position signal comprises the absolute orientation signal.

8. A closeable electronics device, as claimed in claim 1, wherein the user operated screen controller is a group of switches.

9. A closeable electronics device, as claimed in claim 8, wherein he group of switches includes two opposing pairs of switches to provide up, down, left and right movement of the object displayed on the display screen.

10. A closeable electronics device, as claimed in claim 1, wherein the object displayed on the display screen is a cursor.

11. A closeable electronics device, as claimed in claim 1, wherein the object displayed on the display screen is a pointer.

12. A closeable electronics device, as claimed in claim 1, wherein the object displayed on the display screen is an icon.

13. A closeable electronics device comprising:
a housing having at least two portions movably mounted to each other about a pivotal axis to allow relative positions of the portions to be selected between a closed position and an opened position;
a processor housed within the housing;
a display screen mounted to the housing;
a position detector module operatively coupled to the processor; and
a user operated screen controller mounted to the housing and operatively coupled to the processor, wherein in use actuation of the user operated screen controller provides screen control signals that are processed by the processor to control movement of at least one object displayed on the display screen, the screen control signals being dependent on at least one position signal from the position detector module and the position signal being indicative of at least the relative positions of the two portions.

14. A closeable electronics device, as claimed in claim 13, wherein the object is associated with an image displayed on the display screen.

15. A closeable electronics device, as claimed in claim 14, wherein in use, orientation of the image displayed on the display screen is dependent on the position signal.

16. A closeable electronics device, as claimed in claim 13, wherein the position detector module comprises a plurality of position detectors including relative position detectors providing at least one relative orientation signal detecting the relative positions of the two portions, and wherein the position signal comprises the relative orientation signal.

17. A closeable electronics device, as claimed in claim 16, wherein the relative position detectors provide the relative orientation signal that is indicative of a fully opened position and a fully closed position of the portions.

18. A closeable electronics device, as claimed in claim 16, wherein the relative position detectors provide the relative orientation signal that is indicative of intermediate positions disposed between the fully opened position and a fully closed position of the portions.

19. A closeable electronics device, as claimed in claim 16, wherein the plurality of position detectors includes absolute position detectors for providing at least one absolute orientation signal for detecting absolute positions of the portions relative to the earth's surface, wherein the position signal comprises the absolute orientation signal.

20. A closeable electronics device, as claimed in claim 13, wherein the user operated screen controller is a group of switches.

21. A closeable electronics device, as claimed in claim 20, wherein he group of switches includes two opposing pairs of switches to provide up, down, left and right movement of the object displayed on the display screen.

22. A closeable electronics device, as claimed in claim 13, wherein, the object displayed on the display screen is a cursor.

23. A closeable electronics device, as claimed in claim 13, wherein the object displayed on the display screen is a pointer.

24. A closeable electronics device, as claimed in claim 13, wherein the object displayed on the display screen is an icon.

25. A method for configuring operation of a user operated screen controller of a closeable electronics device having a display screen and two portions moveably mounted to each other about a pivotal axis, the method comprising:
determining relative positions of the two portions to provide a position signal; and
configuring operation of the user operated screen controller based on the position signal to thereby control movement of at least one object displayed on the display screen.

26. A method for configuring operation of a user operated screen controller as claimed in claim 25, wherein orientation of a visual representation displayed on the display screen is dependent on the position signal.

27. A method for configuring operation of a user operated screen controller as claimed in claim 26, wherein the object is associated with an image displayed on the display screen.

28. A method for configuring operation of a user operated screen controller as claimed in claim 27, wherein orientation of the image displayed on the display screen is dependent on the position signal.

29. A method for configuring operation of a user operated screen controller as claimed in claim 25, wherein the position signal comprises:
a relative orientation signal that detects the relative positions of the two portions; and
an absolute orientation signal for detecting absolute positions of the portions relative to the earth's surface.

30. A method for configuring operation of a user operated screen controller as claimed in claim 29, wherein the method is further characterised by the user operated screen controller being a group of switches.

31. A method for configuring operation of a user operated screen controller as claimed in claim 30, wherein the group of switches includes two opposing pairs of switches to provide up, down, left and right movement of the object displayed on the display screen.
